(19) United States
(12) Patent Application Publication
(10) Pub. No.: US 2004/0023084 A1
(43) Pub. Date: Feb. 5, 2004

(54) Regenerative pump for hydrogen gas applications and method of using the same

(75) Inventors: John Patrick Sterchi, Ramona, CA (US); Jerry Alan Piontkowski, Escondido, CA (US)

Correspondence Address: PROCOPIO, CORY, HARGREAVES & SAVITCH LLP, 530 B STREET, SUITE 2100, SAN DIEGO, CA, 92101, US

(73) Assignee: H2Systems, Inc.

(21) Appl. No.: 10/633,255

(22) Filed: Aug. 1, 2003

Related U.S. Application Data
(60) Provisional application No. 60/400,741, filed on Aug. 2, 2002.

(51) Int. Cl. H01M 8/04

(52) U.S. Cl. 429/13; 429/22; 429/34

(57) ABSTRACT

A method of replenishing hydrogen in a hydrogen fuel cell stack includes providing a source of hydrogen for the hydrogen fuel cell stack; providing a hydrogen fuel cell stack having an inlet for the introduction of hydrogen and an outlet for the removal of hydrogen; providing a hydrogen delivery and recovery sub-system for supplying hydrogen to and recovering unused hydrogen from the hydrogen fuel cell stack, the hydrogen delivery and recovery sub-system including a hermetically sealed regenerative pump; supplying hydrogen to the hydrogen delivery and recovery sub-system with the source of hydrogen; and pumping hydrogen through the hydrogen delivery and recovery sub-system to and from the hydrogen fuel cell stack using the hermetically sealed regenerative pump.

### CROSS-REFERENCE TO RELATED APPLICATIONS

This application claims the benefit of prior provisional application No. 60/400,741 filed on Aug. 2, 2002.

### FIELD OF THE INVENTION

The present invention is related to a regenerative pump and an anode sub-system using such pump for a fuel cell system or fuel cell engine.

### BACKGROUND OF THE INVENTION

A fuel cell converts chemical energy directly into electrical energy and heat. In general, a fuel cell includes two electrodes—an anode and a cathode—separated by an electrolyte. During use, the anode is supplied with fuel and the cathode is supplied with an oxidizer, which is usually oxygen from air. With the aid of a catalyst, the fuel undergoes oxidation at the anode, producing protons and electrons. The protons diffuse through the electrolyte to the cathode where, in the presence of a second catalyst, the protons combine with oxygen and electrons to produce water and heat. Because the electrolyte acts as a barrier to electron flow, the electrons travel from the anode to the cathode via an external circuit containing an electrical load that consumes power generated by the fuel cell. A single fuel cell generates an electrical potential of about one volt or less, so individual cells are “stacked” in series to achieve a requisite voltage.

Fuel cells (e.g., hydrogen fuel cells) have been proposed as replacements for internal combustion engines in vehicles due to their high efficiency, their potential for fuel flexibility, and their ability to generate electricity with zero or near zero emission of pollutants. Research and infrastructure development commitments by the Federal Government, energy producers and suppliers, and automobile manufacturers have indicated that pressurized hydrogen gas is the preferred energy storage medium for automotive fuel cell application because hydrogen has excellent electrochemical reactivity, provides sufficient power density levels in an air-oxidized system, and produces only water upon reaction.

FIG. 1 is a simple schematic diagram of a typical anode sub-system 40 of a hydrogen-based fuel cell system for an automotive fuel cell application. The anode sub-system 40 may include three primary components: a storage tank 50, a hydrogen delivery and recovery sub-system (HDRS) 60, and an anode of a fuel cell stack 70. While proper design of each of these components is critical to efficient and robust operation of the overall hydrogen-based fuel cell system, the HDRS 60 must account for issues such as humidification and water management, thermal management, anode tail-gas recirculation, and hydrogen flow control.

The purpose of the HDRS 60 is to regulate and condition the flow of hydrogen fuel from the storage tank 50, as well as return unreacted hydrogen, along with water and dilution gases such as nitrogen, to the fuel cell stack 70. In general, the HDRS 60 must provide adequate humidification, thermal management, recirculation, and flow control of the fuel.

In regard to the recirculation provided by the HDRS 60, in order to prevent the degradation of the anode electrode, it is imperative that a flow rate of hydrogen gas greater than the stoichiometric value required be supplied to the stack 70. This is true for three primary reasons: 1) As with any chemical reactor, 100% reactant conversion will not occur. Note that higher reactant conversion, in general, will require a larger reactor and/or more catalyst for a given flow rate and temperature. 2) Excess hydrogen must be supplied to each cell to ensure adequate distribution throughout the cell (especially at low power). 3) Since hydrogen is typically supplied through a manifold with each cell connected in parallel, variation in flow resistance from cell to cell will create a non-uniform hydrogen gas delivery to each cell.

These factors lead to the certainty that some amount of fuel “overstoich” is required to maintain the health of the stack 70. While the amount of overstoich required is dependent on many design and operating condition variables, there is a significant, and in some cases substantial, amount of hydrogen passing through the stack 70 unused at the anode exit. Without some way of utilizing this excess hydrogen, there is a detrimental effect on the system efficiency as well as system safety.

The preferred solution to the problem presented by overstoich of the stack 70 is to recirculate unused hydrogen back to the inlet of the stack 70. Since there is pressure drop across the stack 70, this can only be accomplished by some type of pumping device and recirculation line from the exit to the inlet of the stack 70. Pumping devices used in the past in the recirculation line have been unsatisfactory because 1) they use too much power and are too large, 2) they are not durable devices, and 3) they have regions of inadequate operation. The present invention overcomes these problems by utilizing a regenerative impeller design to reduce blower size, as well as reducing blower speed, thereby increasing durability. In addition, there are no “dead zones” of operation (with regard to item 3) that would be present in a staged ejector configuration.

### SUMMARY OF THE INVENTION

Accordingly, an aspect of the invention involves a method of replenishing hydrogen in a hydrogen fuel cell stack including the steps of providing a source of hydrogen for the hydrogen fuel cell stack; providing a hydrogen fuel cell stack having an inlet for the introduction of hydrogen and an outlet for the removal of hydrogen; providing a hydrogen delivery and recovery sub-system for supplying hydrogen to the inlet of the hydrogen fuel cell stack and recovering unused hydrogen from the outlet of the hydrogen fuel cell stack, the hydrogen delivery and recovery sub-system including a hermetically sealed regenerative pump to pump hydrogen through the hydrogen delivery and recovery sub-system and hydrogen fuel cell stack; supplying hydrogen to the hydrogen delivery and recovery sub-system with the source of hydrogen; and pumping hydrogen through the hydrogen delivery and recovery sub-system to and from the hydrogen fuel cell stack using the hermetically sealed regenerative pump.

One or more implementations of the aspect of the invention described immediately above may include one of more of the following. The hermetically sealed regenerative pump includes an inner chamber and one or more passages within the inner chamber that hydrogen flows through, and at least one of the one or more passages include a relief hole to balance the pressure between an inside of the one or more passages with the relief hole and the inner chamber. The hermetically sealed regenerative pump includes an impeller, a motor with a rotating shaft to rotate the impeller, and an anti-rotation mechanism prevents the shaft from rotating relative to the impeller. The impeller includes an incurved channel and the shaft includes an incurved channel alignable with each other to form a bore, and the anti-rotation mechanism includes a rod disposed in the bore formed by the aligned incurved channels of the impeller and the shaft. A current controller is used to set and maintain the motor at a constant power level, preventing overheating of the motor.

Another aspect of the invention involves an anode sub-system of a hydrogen-based fuel cell system including a hydrogen storage tank; an anode of a hydrogen fuel cell stack; and a hydrogen delivery and recovery sub-system including a hermetically sealed regenerative pump to pump unused hydrogen from the anode of the hydrogen fuel cell stack through the hydrogen delivery and recovery sub-system to and from the hydrogen fuel cell stack.

One or more further implementations of the anode sub-system described immediately above may include one or more of the following. The hermetically sealed regenerative pump includes an inner chamber and one or more passages within the inner chamber that hydrogen flows through, and at least one of the one or more passages including a relief hole to balance the pressure between an inside of the one or more passages with the relief hole and the inner chamber. The hermetically sealed regenerative pump includes an impeller, a motor with a rotating shaft to rotate the impeller, and an anti-rotation mechanism to prevent the shaft from rotating relative to the impeller. The impeller includes an incurved channel and the shaft includes an incurved channel alignable with each other to form a bore, and the anti-rotation mechanism includes a rod disposed in the bore formed by the aligned incurved channels of the impeller and the shaft. A current controller is used to set and maintain a constant power level in the motor, preventing overheating of the motor.

A further aspect of the invention involves a hermetically sealed regenerative pump of an anode sub-system of a hydrogen-based fuel cell system. The hermetically sealed regenerative pump includes a hermetically sealed enclosure including an inner chamber; a motor disposed within the inner chamber of the hermetically sealed enclosure and including a rotatable shaft; an impeller connected to the rotatable shaft and rotatable therewith to pump hydrogen through the anode sub-system of the hydrogen-based fuel cell system; and one or more passages within the inner chamber that hydrogen flows through, at least one of the one or more passages including a relief hole to balance the pressure between an inside of the one or more passages with the relief hole and the inner chamber.

One or more further implementations of the hermetically sealed regenerative pump described immediately above may include one or more of the following. The hermetically sealed regenerative pump may include anti-rotation mechanism to prevent the shaft from rotating relative to the impeller. The impeller includes an incurved channel and the shaft includes an incurved channel alignable with each other to form a bore, and the anti-rotation mechanism includes a rod disposed in the bore formed by the aligned incurved channels of the impeller and the shaft. A current controller is used to set and maintain a constant power level in the motor, preventing overheating of the motor.

Further objects and advantages will be apparent to those skilled in the art after a review of the drawings and the detailed description of the preferred embodiments set forth below.

### BRIEF DESCRIPTION OF THE DRAWINGS

FIG. 1 is a schematic view of an anode sub-system of a hydrogen-based fuel cell system.

FIG. 2 is a cross-sectional view of an embodiment of a regenerative pump that may be used with the anode gas recirculation system of FIG. 1.

FIG. 3 is a cross-sectional view of an alternative embodiment of a regenerative pump that may be used with the anode gas recirculation system of FIG. 1.

FIG. 4 is an exploded cross-sectional view of the regenerative pump of FIG. 3.

FIG. 5A is a front-elevational view of an embodiment of a motor that may be used with the regenerative pump of FIGS. 3 and 4.

FIG. 5B is a right side-elevational view of the motor illustrated in FIG. 5A.

FIG. 6A is a left side elevational view of an embodiment of an impeller that may be used with the regenerative pump of FIGS. 3 and 4.

FIG. 6B is a cross-sectional view of the impeller of FIG. 6A taken along lines 6B-6B of FIG. 6A.

FIG. 7A is a left side elevational view of an embodiment of a first housing member that may be used with the regenerative pump of FIGS. 3 and 4.

FIG. 7B is a cross-sectional view of the first housing member of FIG. 7A taken along lines 7B-7B of FIG. 7A.

FIG. 8A is a left side elevational view of an embodiment of a second housing member that may be used with the regenerative pump of FIGS. 3 and 4.

FIG. 8B is a cross-sectional view of the second housing member of FIG. 8A taken along lines 8B-8B of FIG. 8A.

FIG. 9A is a left side elevational view of an embodiment of a first endcap that may be used with the regenerative pump of FIGS. 3 and 4.

FIG. 9B is a cross-sectional view of the first endcap member of FIG. 9A taken along lines 9B-9B of FIG. 9A.

FIG. 10A is a left side elevational view of an embodiment of a casing that may be used with the regenerative pump of FIGS. 3 and 4.

FIG. 10B is a cross-sectional view of the casing of FIG. 10A taken along lines 10B-10B of FIG. 10A.

FIG. 11A is a right side elevational view of an embodiment of a second endcap that may be used with the regenerative pump of FIGS. 3 and 4.

FIG. 11B is a cross-sectional view of the second endcap member of FIG. 11A taken along lines 11B-11B of FIG. 11A.

FIG. 12 is a front elevational view of an embodiment of a tube connector that may be used with the regenerative pump of FIGS. 3 and 4.

FIG. 13 is a graph of performance curves for the regenerative pump illustrated in FIGS. 3-12 for a variety of different motor speeds and density fluids.

### DETAILED DESCRIPTION OF PREFERRED EMBODIMENTS

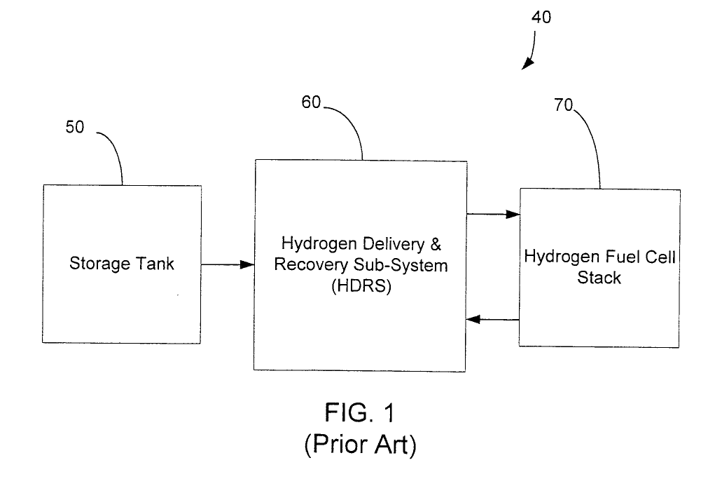

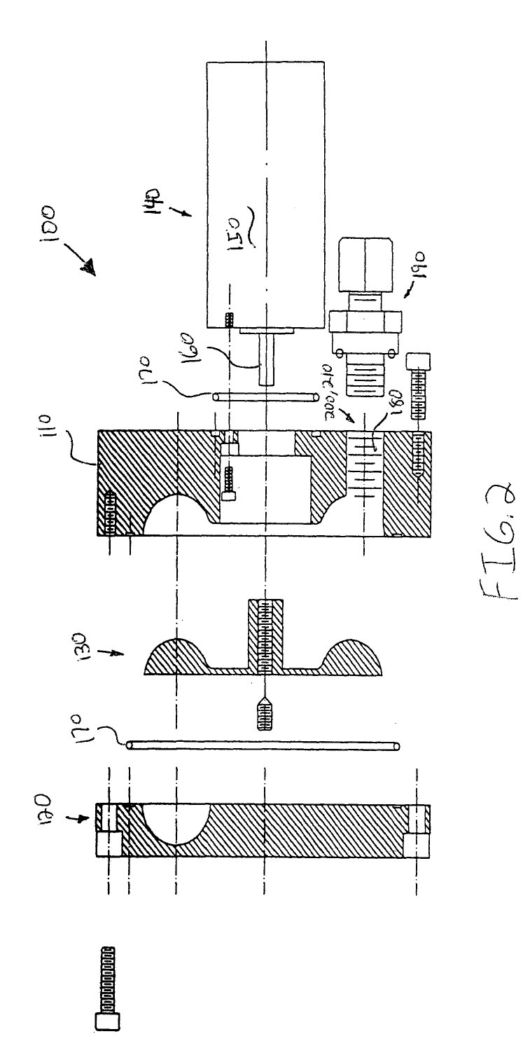

FIG. 2 illustrates an embodiment of a regenerative pump, vortex blower pump, or side-channel blower 100 (hereinafter “regenerative pump” or “pump” 100) that may be used with the anode stream recirculation system 40 (FIG. 1) of a hydrogen-based fuel cell system. Although the regenerative pump 100 will be described as being used in the anode stream recirculation system 40 of a hydrogen-based fuel cell system in an automobile application, the regenerative pump 100 may be used in a recirculation system of other types of proton exchange membrane fuel cell systems and/or for applications other than an automobile.

The regenerative pump 100 may be used to pump pure gaseous hydrogen or a mixture of hydrogen and some other species. The pump 100 includes an inner case 110, an outer case 120, an impeller 130, an electric motor 140, and a controller/amplifier (not shown) for the motor 140. The inner case 110 is attached to a body 150 of the motor 140, the impeller 130 is attached to a motor shaft 160, and the outer case 120 is attached to the inner case 110 to form a torroidal shaped enclosure. Various o-rings 170 act to seal the enclosure from leakage. Process fluids enter and exit the pump 100 through ports 180 on the inner case 110.

The inner case 110, outer case 120, and the impeller 130 may be machined of case from metal, plastic, or composite materials. The motor 140 may be an electrically-commutated DC brushless type, and is controlled by the external amplifier/controller. Fittings 190 and o-rings 170 can be constructed of any number of materials and may be of standard sizes.

The pump 100 operates when an external DC voltage is applied to the motor 140. This activates the motor 140, which causes the enclosed impeller 130 to rotate. As the impeller 130 spins, a centrifugal, regenerative pumping action is imposed on the enclosed fluid. As the control voltage to the motor 140 is raised, the rotational speed of the impeller 130 increases and there is a corresponding increase in work transferred to the enclosed fluid. The increased rotational speed results in the flow rate of the gas increasing, and the added work causes the differential pressure between outlet 200 and inlet 210 of the pump 100 to be elevated.

Some of the features that make the pump 100 ideal for pumping pure gaseous hydrogen or a mixture of hydrogen and some other species, include, but not by way of limitations: 1) the use of the brushless motor 140 prevents arcing and, therefore, one potential source of ignition; 2) the design of the pump 140 results in a very low potential for leakage of fluid from the enclosed (internal) volume of the pump 100; and 3) the regenerative pumping action of the pump 100 is ideal for producing significant pressure rise in a low density fluid such as hydrogen.

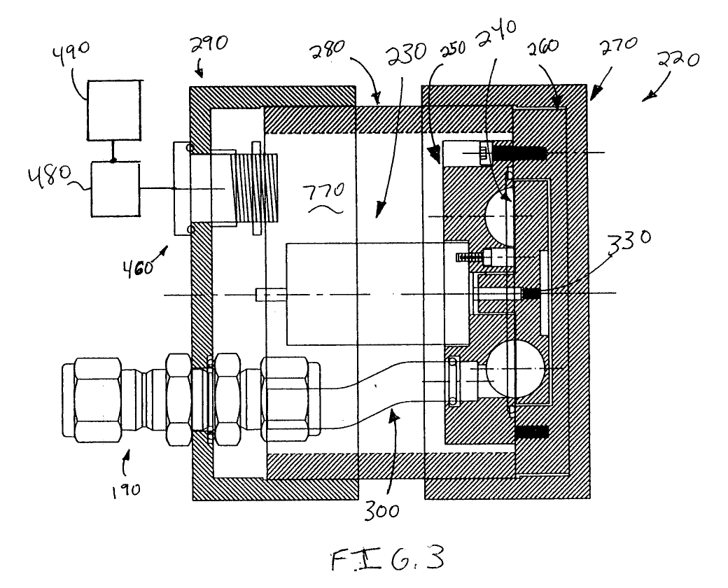

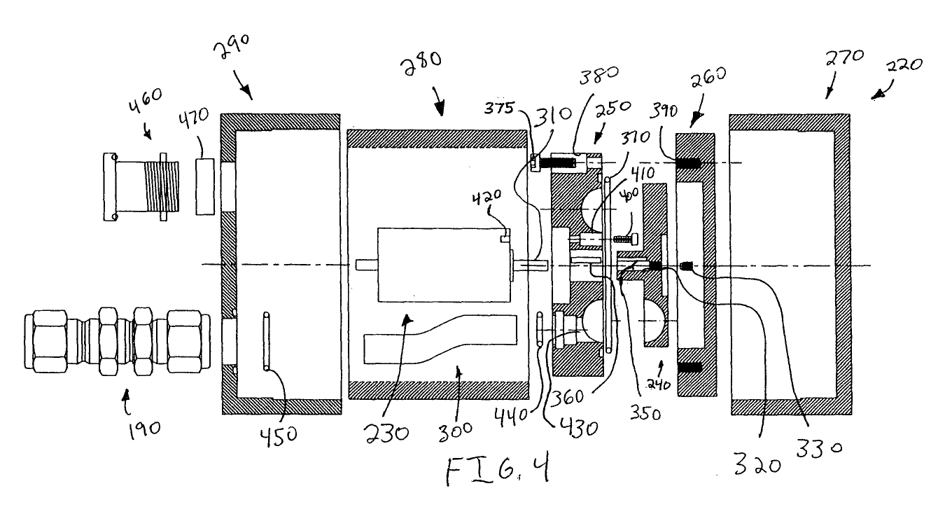

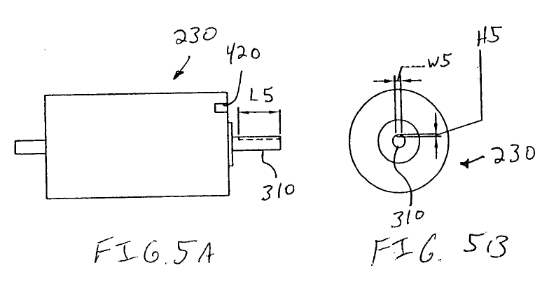

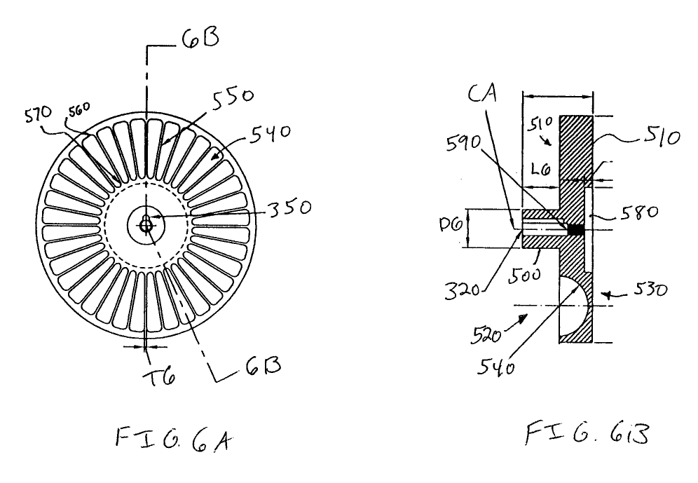

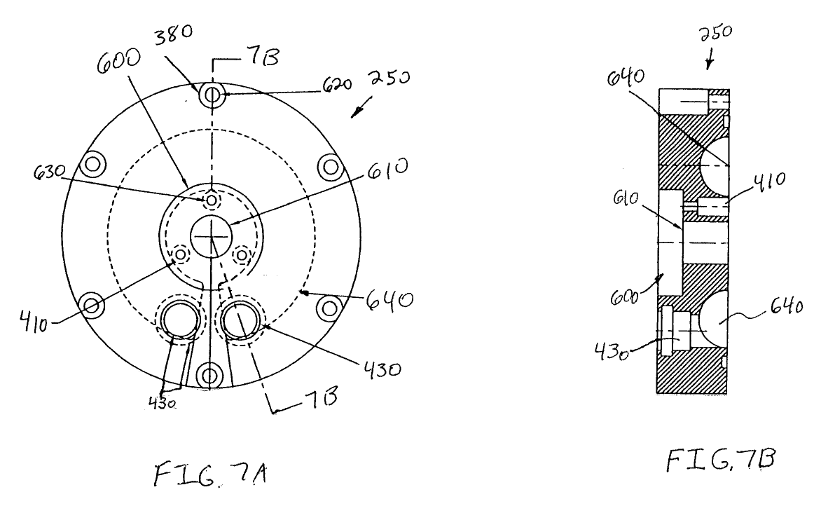

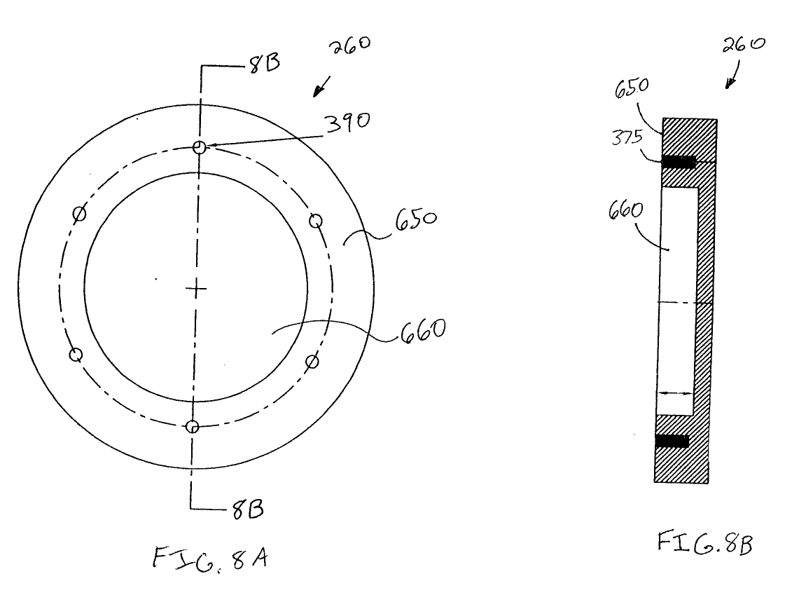

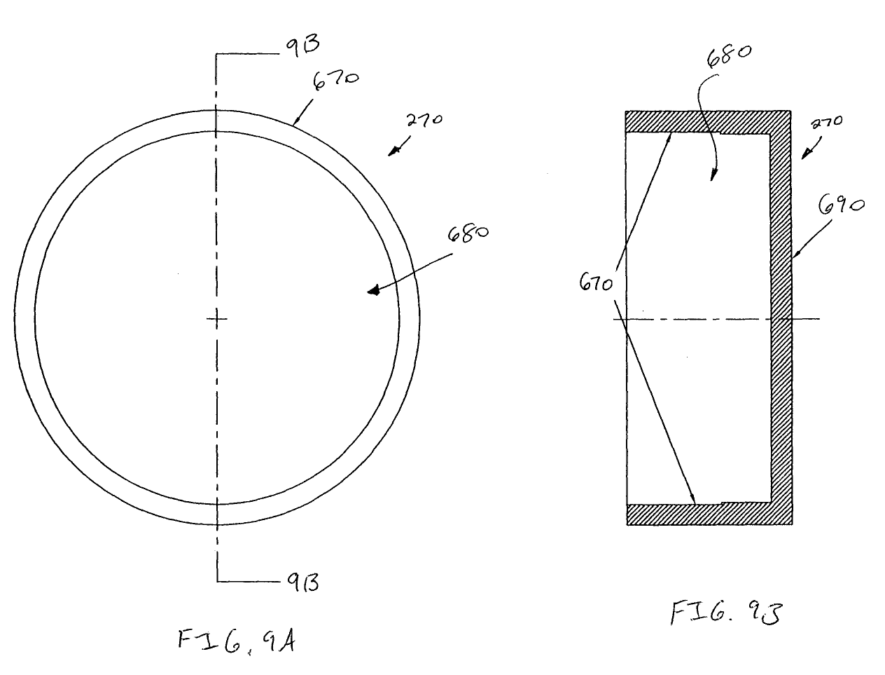

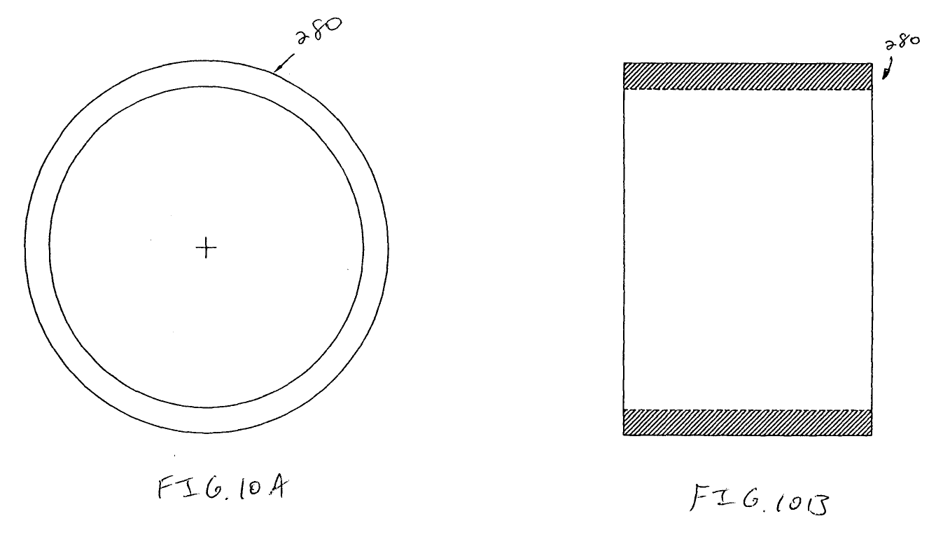

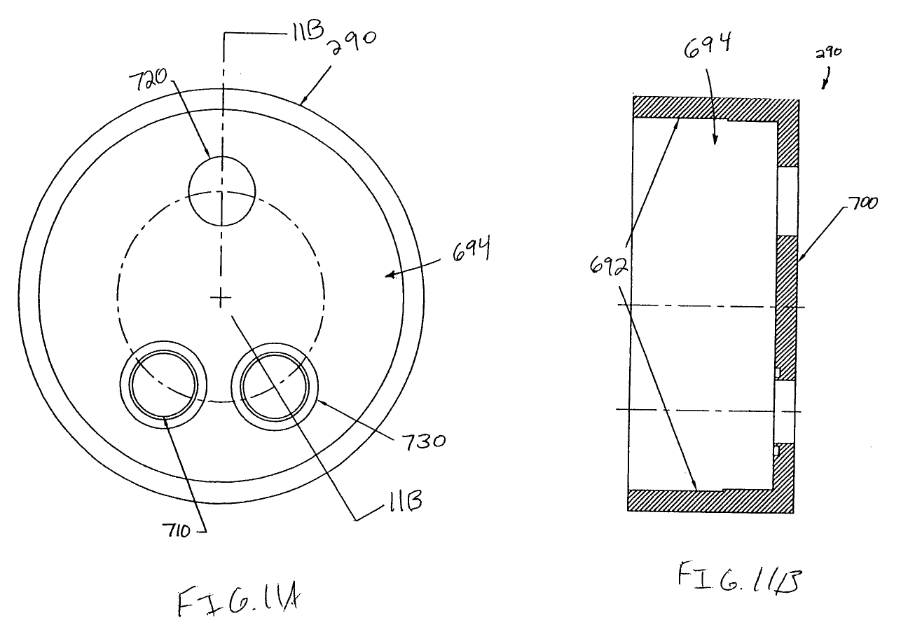

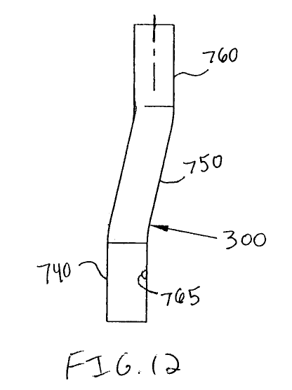

With reference to FIGS. 3-12, and initially FIGS. 3 and 4, an alternative embodiment of a regenerative pump, vortex blower pump, or side-channel blower 220 (hereinafter “regenerative pump” or “pump” 220) that may be used with the anode gas recirculation system 40 of FIG. 1 will now be described. The regenerative pump includes a DC brushless servomotor 230 (FIGS. 5A, 5B), an impeller 240 (FIGS. 6A, 6B), a first housing member 250 (FIGS. 7A, 7B), a second housing member or cover 260 (FIGS. 8A, 8B), a first endcap 270 (FIGS. 9A, 9B), a casing 280 (FIGS. 10A, 10B), a second endcap 290 (FIGS. 11A, 11B), and tube connectors 300 (FIG. 12).

With reference to FIGS. 3 and 4, a cylindrical shaft 310 of the motor 230 is matingly received by a corresponding cylindrical bore 320 of the impeller 240. A screw 330 may be used to attach the impeller 240 to a distal end of the shaft 310, thereby preventing impeller slippage in the axial direction towards the motor. The shaft 310 includes an elongated incurved channel 340 (FIGS. 5A, 5B) extending along the majority of the length of the shaft 310. The bore 320 of the impeller 240 includes a corresponding opposite incurved channel 350 (FIGS. 6A, 6B) extending along the majority of the length of the bore 320. A vinyl rod 360 is disposed in the opposite, aligned incurved channels 340, 350 when the impeller 240 is connected to the shaft 310 to prevent the shaft 310 from rotating relative to the impeller 240 (as opposed to with the impeller 240) during rotation of the shaft 310. In alternative embodiments, the rod 360 may be a material other than vinyl or may have a different configuration. The rod 360 acts as an anti-rotation key or anti-rotation mechanism that prevents the shaft 310 from rotating relative to the impeller 240.

An o-ring 370 may be disposed between engagement surfaces of the first housing member 250 and the second housing member 260. The first housing member 250 and the second housing member 260 may be connected to each other using multiple screws 375 that extend though bores 380 in the first housing member 250 and are threadably engaged with threaded bores 390 of the second housing member 260. The first housing member 250 and the motor 230 may be connected to each other using multiple screws 400 that extend though bores 410 in the first housing member 250 and are threadably engaged with threaded bores 420 at an end of the motor 230.

Communication bores 430 in the first housing member 250 communicate with fittings 190 through respective tube connectors 300. O-rings 440 may be disposed near the joinder of the tube connectors 300 with the communication bores 430 of the first housing member 250 and o-rings 450 may be disposed near the joinder of the tube connectors 300 with the fittings 190.

A hermetic panel receptacle 460 may be hermetically connected to and hermetically sealed with respect to the second endcap 290. A shaft of the panel receptacle 460 may be received by a receptacle spacer 470, which occupies space between the endcap 290 and the threaded portion of the receptacle 460, allowing for a secure attachment. Electronic connections (not shown) to the motor 230 extend through the panel receptacle 460.

With reference to FIG. 3, the pump 220 may be controlled using a current controller 480 connected to the motor 230 and a power supply 490. That is, the current into the motor 230 will be set and maintained. In the embodiment shown, where the motor 230 uses an input voltage of 36-48 V DC, a fixed current between 1.0 and 3.0 A is desired. This strategy has the following advantages: 1) it simplifies the control strategy greatly, in part by making an open-loop system where no feedback is required to maintain a controlled condition; and 2) it will prevent overheating of the motor 230, as a fixed voltage and fixed current will result in a fixed power input (P=V*I) to the motor 230—this is important because of the possibility of different density gases being pumped depending on the condition of the fuel cell. Generally, the fluid in the fuel cell anode will range in density from 0.1 to 0.8 kg/m\hat{ }3. Therefore, the pump 220 must accommodate these variations. If a fixed speed were maintained, the motor 230 would overheat with the higher density fluid (since power used is proportional to density for a given pump and speed). By using current control, the motor speed will automatically adjust to changes in fluid density, and therefore run at a constant power level—if this strategy were not used, the fluid density must be estimated and motor speed would have to be adjusted accordingly, which is not easy to do.

In an alternative embodiment, the pump 220 may be controlled using a speed controller.

In an alternative embodiment, the motor 230 may utilize a heat exchange device such as a water jacket or cooling fins to maintain the temperature of the motor below a maximum threshold.

With reference to FIGS. 5A-12, the main components of the pump 220 will now be described in more detail in turn below.

FIGS. 5A and 5B illustrate the DC brushless servomotor 230. FIG. 5A illustrates that the elongated incurved channel 340 of the shaft 310 has a length L5 that is at least a majority of the length of the shaft 310, and, in the embodiment shown, substantially the length of the shaft 310. FIG. 5B illustrates the incurved channel 340 having a width W5 and a height H5. The vinyl rod 360 is disposed partially in the incurved channel 340 and partially in the incurved channel 350 of the bore 320 of the impeller 240 to prevent the shaft 310 from rotating relative to the impeller 240.

FIGS. 6A and 6B illustrate the impeller 240. The impeller 240 includes a shaft 500 and a head 510. The shaft 500 includes the bore 320 with the incurved channel 350 discussed above for partially receiving the vinyl rod 360. The shaft 500 includes a length L6 and a diameter D6. The head 510 includes a first side 520 and a second side 530. The first side 520 includes a plurality of wedge-shaped fluid channels 540 separated by blades 550 of a thickness T6. The fluid channels 540 include outer ends 560 and inner ends 570. The fluid channels 540 may have a semicircular cross-section as shown in FIG. 6B. Although 36 fluid channels 540 are shown, other numbers of fluid channels 540 or different configuration fluid channels 540 may be used. For example, but not by way of limitation, one or more of the number of blades 550, the angle of the blades 550, and the configuration of the blades 550 may be different in alternative embodiments of the impeller 240. The second side 530 of the head 510 include a circular recess 580. The screw 330 for connecting the impeller 240 to the end of the motor shaft 310 is inserted through the circular recess 580 and a bore 590 sunk in the recess 580. The impeller 240 rotates with the shaft 310 about an imaginary central axis CA. As the 240 impeller rotates, fluid is drawn into toroidal fluid path 640 through either one of the two receiving passages 430 (depending on the direction of rotation) where it is accelerated from the inner torroidal radius to the outer toroidal radius. The flow is then redirected several times over course of passage through the device for additional acceleration, hence the term regenerative pump.

FIGS. 7A and 7B illustrate the first housing member 250. The first housing member 250 includes a circular recess 600 that receives a top of the housing of the motor 230 and a sunk circular bore 610 that receives the shaft 500 of the impeller 240. Bores 380 include counter bores 620 for receiving the screws 375 and bores 410 include counter bores 630 for receiving the screws 400. The communication bores 430 communicate with penannular, generally toroidal fluid path 640. The portion of the fluid path 640 in the first housing member 250 has a semicircular cross-section as shown in FIG. 7B. Fluid flows from an inlet communication bore 430 to an outlet communication bore 430 via the fluid path 640.

FIGS. 8A and 8B illustrate the second housing member 260. The second housing member 260 has a short cylindrical cup-shaped or dish-shaped configuration with an annular ledge 650 and a circular recess 660 that receives the head 510 of the impeller 240. The threaded bores 390 receive the multiple screws 375 for attaching the first housing member 250 to the second housing member 260.

FIGS. 9A and 9B illustrate the first endcap member 270. The first endcap member 270 has a cylindrical cup-shaped or dish-shaped configuration with an annular wall 670 and a circular recess 680 formed by the annular wall 670 and a bottom 690 to receive the second housing member 260 and a portion of the casing 280.

FIGS. 10A and 10B illustrate the casing 280. The casing 280 has a tubular configuration and forms the main outer housing for the pump 220.

FIGS. 11A and 11B illustrate the second endcap member 290. The second endcap member 290 has a cylindrical cup-shaped or dish-shaped configuration with an annular wall 692, a circular recess 694 formed by the annular wall 692, and a bottom 700 that receives fittings 190 through bores 710 and the hemetic panel receptacle 460 through bore 720. Square o-ring grooves 730 surround bores 710 for receiving the o-rings 450.

During assembly, the tubular first end cap 270 and the tubular second end cap 290 are slid onto the tubular casing 280, and preferably fixed and hermetically sealed thereto with an appropriate adhesive. This assembly along with the o-rings and other hermetic connections prevents hydrogen from escaping the pump 220 and to a large extent from entering into the motor 230, providing an overall hermetically sealed regenerative pump assembly.

FIG. 12 illustrates one of the tube connectors 300 used to communicate the bores 430 in the first housing member 250 with the fittings 190. In the embodiment shown, the tube connector 300 is an inlet tube connector 300 (although this depends on the rotational direction of the impeller 240) that includes a straight first portion 740, an angled intermediate second portion 750, and a straight third portion 760. The first portion 740 may include a relief hole 765 to balance the pressure between the inside of the inlet tube connector 300 and inner chamber 770 of the pump 220. Balancing the pressure at the two described locations inhibits the flow of humidified gases through the motor housing, which could be detrimental to the life of the motor 230. Although the relief hole 765 is shown and described as being as single relief hole 765 in the straight first portion 740 of the tube connector 300, in alternative embodiments, the relief hole 765 may be one or more relief holes 765 in one or more of the straight first portion 740, the angled intermediate second portion 750, the straight third portion 760, or other passages in the chamber 770.

Components of the pump 220 should be fabricated from materials that can meet the mechanical, electrical, thermal, and other design requirements of vehicles, including mass, volume, and cost. The materials should also be compatible with the assembly's working environment. For example, the enclosure formed by the first end cap 270, second end cap 290, and casing 280 should be able to resist attack by compounds present in the engine compartment of the vehicle (e.g., road contaminants). Similarly, the components of the pump 220 should be able to resist attack by corrosive constituents of the anode gas re-circulation stream, including water, which may condense during startup and shutdown of the fuel cell system. Care should also be taken to ensure that the components of the pump 220 release minimal amounts of certain ions—i.e., chlorine and metal ions—into the anode gas re-circulation stream. In most cases, the pump 220 should also avoid the use of lubricants that may volatilize at motor and pump operating temperatures. Useful fabrication materials include anodized aluminum, stainless steel, and thermally stable plastic. It is also important that the thermal expansion of the components of the pump 220 are matched.

The regenerative pump 220 will now be described in use. Unused hydrogen exits the hydrogen fuel cell stack 70 and the regenerative pump 220 of the hydrogen delivery and recovery sub-system 60 pumps, blows, raises the pressure of, or recirculates the unused hydrogen back to the inlet of the stack 70. The hydrogen enters the pump 220 at an inlet fitting 190 and passes through an inlet tube connector 300 to the inlet communication bore 430 of the first housing member 250. The relief hole 765 in the first portion 740 causes the pressure between the inside of the inlet tube connector 300 and inner chamber 770 of the pump 220 to equalize, thereby greatly reducing the amount of fluid that passes through the motor housing. The rotating impeller 240 causes hydrogen to flow under pressure through the fluid path 640 of the first housing member 250, exit the pump 220 through outlet fitting 190 and the outlet tube connector 300, and back to the inlet of the stack 70. During rotation of the impeller 240, the rod 360 disposed in the opposite, aligned incurved channels 340, 350 of the motor shaft 310 and the impeller shaft 500 prevents the shaft 310 from rotating relative to the impeller 240. The current controller 480 is used to set and maintain the current of the motor 230, simplifying the control strategy of the pump 220 and preventing overheating of the motor 230 (the motor speed will automatically adjust to changes in fluid density, and therefore run at a constant power level, preventing overheating of the motor 230).

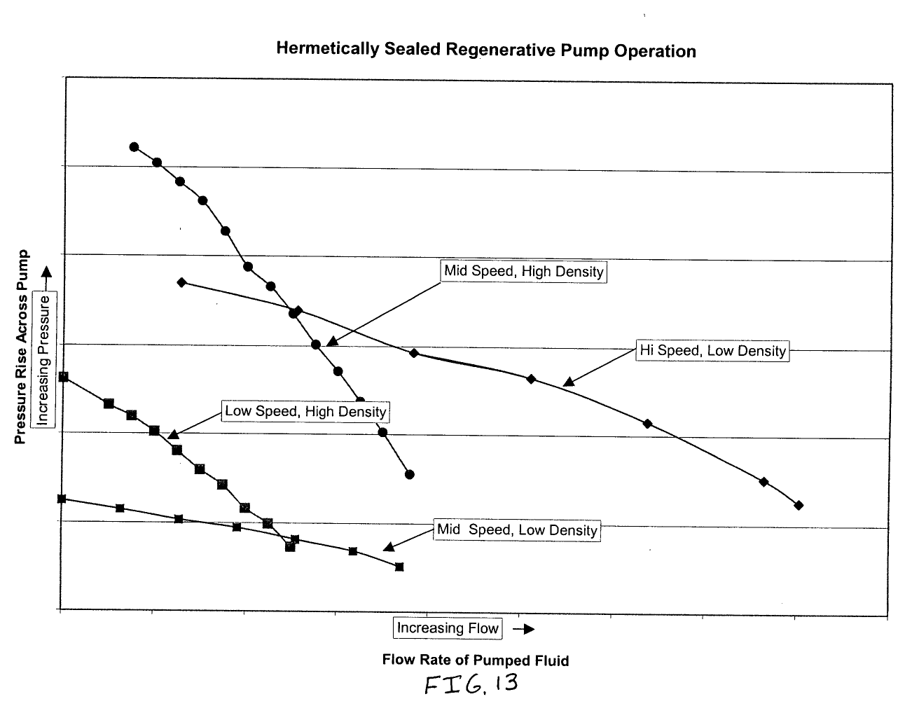

FIG. 13 is a graph of performance curves for the regenerative pump 220 illustrated in FIGS. 3-12 for a variety of different motor speeds and density fluids. The regenerative pump 220 used is known as model L sold by H2 Systems, Inc. of Ramona, Calif.

The regenerative pump 220 is advantageous over other pumps such as single stage centrifugal pumps used in the past in hydrogen delivery and recovery sub-systems 60 of hydrogen-based fuel cell systems because, among other things, the regenerative pump 220 provides more of a pressure rise in the hydrogen delivery and recovery sub-systems 60 for a given set of conditions than other centrifugal pumps. As a result, the regenerative pump 220 is smaller, lower in weight, and operates at a more suitable condition relative to the longevity of the device. In addition, the present invention allows for opportunities to (in conjunction with other devices) lower the electrical energy required to operate the anode sub-system 40 so that the overall efficiency of electrical power generation for the fuel cell system is promoted.

The pressure rise produced by a centrifugal pump or a regenerative pump will be proportional to the kinetic energy added to the fluid, that is

Δp∝ρ·V²

so for a given fluid (ρ is fixed), the Δp will be proportional to V².

With respect to the disclosed application, the velocity of importance is the vane tip velocity, which will be equal to the impeller rotational speed times the circumference of the impeller:

V=rpm*D*Π

Since this is the case, the pressure rise will be proportional to

v²=rpm²*D²*Π²

So,

Δp=C·ρ·rpm²·D²

or

Δp=C·ρ·rpm²·D²

where C is a constant.

For a typical centrifugal pump values might be as follows for standard air (ρ=1.2 kg/m³):

dp=50000 Pa

rpm=40000=667 rps

D=15 cm 0.15 m

So C*ρ=5.0 Pa/(m/s)².

For the regenerative pump 220,

Dp=25000Pa

Rpm=28000=467 rps

D=7 cm=0.07 m

C*ρ=23.4 Pa/(m/s)²

Thus, more pressure rise for a given set of conditions occurs in the hydrogen delivery and recovery sub-system 60 using the regenerative pump 220 compared to a typical centrifugal pump. This is especially important in recirculating hydrogen as the density can be very low with hydrogen, and therefore the constant C must be high to achieve any appreciable pressure rise with the device. The fact that the constant C for the regenerative pump is approximately 4 to 5 times that of the compared pump indicates that the regenerative pump will provide a higher pressure rise for the same size pump, and an equal pressure rise for a significantly smaller pump with a lower rotational speed.

It will be readily apparent to those skilled in the art that still further changes and modifications in the actual concepts described herein can readily be made without departing from the spirit and scope of the invention as defined by the following claims.

What is claimed is:

1. A method of replenishing hydrogen in a hydrogen fuel cell stack, comprising:
providing a source of hydrogen for the hydrogen fuel cell stack;
providing a hydrogen fuel cell stack having an inlet for the introduction of hydrogen and an outlet for the removal of hydrogen;
providing a hydrogen delivery and recovery sub-system for supplying hydrogen to the inlet of the hydrogen fuel cell stack and recovering unused hydrogen from the outlet of the hydrogen fuel cell stack, the hydrogen delivery and recovery sub-system including a hermetically sealed regenerative pump to pump hydrogen through the hydrogen delivery and recovery sub-system and hydrogen fuel cell stack;
supplying hydrogen to the hydrogen delivery and recovery sub-system with the source of hydrogen;
pumping hydrogen through the hydrogen delivery and recovery sub-system to and from the hydrogen fuel cell stack using the hermetically sealed regenerative pump.

2. The method of claim 1, wherein the hermetically sealed regenerative pump includes an inner chamber and one or more passages within the inner chamber that hydrogen flows through, at least one of the one or more passages including a relief hole to balance the pressure between an inside of the one or more passages with the relief hole and the inner chamber.

3. The method of claim 1, wherein the hermetically sealed regenerative pump includes an impeller, a motor with a rotating shaft to rotate the impeller, and an anti-rotation mechanism to prevent the shaft from rotating relative to the impeller.

4. The method of claim 3, wherein the impeller includes an incurved channel and the shaft includes an incurved channel alignable with each other to form a bore, and the anti-rotation mechanism includes a rod disposed in the bore formed by the aligned incurved channels of the impeller and the shaft.

5. The method of claim 1, further including a motor to operate the hermetically sealed regenerative pump and a current controller to set and maintain the current of the motor, and the method further including using the current controller to run the motor at a constant power level, preventing overheating of the motor.

6. An anode sub-system of a hydrogen-based fuel cell system, comprising:
a hydrogen storage tank;
an anode of a hydrogen fuel cell stack;
and a hydrogen delivery and recovery sub-system including a hermetically sealed regenerative pump to pump unused hydrogen from the anode of the hydrogen fuel cell stack through the hydrogen delivery and recovery sub-system to and from the hydrogen fuel cell stack.

7. The anode sub-system of claim 6, wherein the hermetically sealed regenerative pump includes an inner chamber and one or more passages within the inner chamber that hydrogen flows through, at least one of the one or more passages including a relief hole to balance the pressure between an inside of the one or more passages with the relief hole and the inner chamber.

8. The anode sub-system of claim 6, wherein the hermetically sealed regenerative pump includes an impeller, a motor with a rotating shaft to rotate the impeller, and an anti-rotation mechanism to prevent the shaft from rotating relative to the impeller.

9. The anode sub-system of claim 8, wherein the impeller includes an incurved channel and the shaft includes an incurved channel alignable with each other to form a bore, and the anti-rotation mechanism includes a rod disposed in the bore formed by the aligned incurved channels of the impeller and the shaft.

10. The anode sub-system of claim 6, wherein the hermetically sealed regenerative pump includes a motor to operate the hermetically sealed regenerative pump and a current controller to set and maintain a constant power level in the motor, preventing overheating of the motor.

11. A hermetically sealed regenerative pump of an anode sub-system of a hydrogen-based fuel cell system, comprising:
a hermetically sealed enclosure including an inner chamber;
a motor disposed within the inner chamber of the hermetically sealed enclosure and including a rotatable shaft;
an impeller connected to the rotatable shaft and rotatable therewith to pump hydrogen through the anode sub-system of the hydrogen-based fuel cell system;
one or more passages within the inner chamber that hydrogen flows through, at least one of the one or more passages including a relief hole to balance the pressure between an inside of the one or more passages with the relief hole and the inner chamber.

12. The hermetically sealed regenerative pump of claim 11, further including an anti-rotation mechanism to prevent the shaft from rotating relative to the impeller.

13. The hermetically sealed regenerative pump of claim 12, wherein the impeller includes an incurved channel and the shaft includes an incurved channel alignable with each other to form a bore, and the anti-rotation mechanism includes a rod disposed in the bore formed by the aligned incurved channels of the impeller and the shaft.

14. The hermetically sealed regenerative pump of claim 11, further including a current controller to set and maintain a constant power level in the motor, preventing overheating of the motor.
